(19) United States
(12) Patent Application Publication
(10) Pub. No.: US 2025/0387902 A1
(43) Pub. Date: Dec. 25, 2025

(54) BIN WALL COLLISION DETECTION FOR ROBOTIC BIN PICKING

(71) Applicant: Siemens Aktiengesellschaft, Munich (DE)

(72) Inventors: Ines Ugalde Diaz, Redwood City, CA (US); Eugen Solowjow, Berkeley, CA (US); Yash Shahapurkar, Berkeley, CA (US); Husnu Melih Erdogan, Berkeley, CA (US); Eduardo Moura Cirilo Rocha, Albany, CA (US)

(73) Assignee: Siemens Aktiengesellschaft, Munich (DE)

(21) Appl. No.: 18/880,314

(22) PCT Filed: Jul. 18, 2022
(86) PCT No.: PCT/US2022/037439

§ 371 Date: Dec. 31, 2024

(51) Int. Cl. B25J 9/16; B25J 5/00

(52) U.S. Cl. CPC B25J 9/1612; B25J 5/007; B25J 9/1666

(57) ABSTRACT

Bin picking refers to a robot grasping objects that can define random or arbitrary poses, from a container or bin. The robot can move or transport the objects, and place them at a different location for packaging or further processing. It is recognized herein, however, that current approaches to robotic picking lack efficiency and capabilities. In particular, current approaches often do not properly or efficiently identify certain clearances associated with a given robot to execute various grasps, due to various technical challenges in doing so. During runtime of a robot, various clearance dimensions associated with the robot executing a grasp are determined. In particular, for example, during runtime the robot can determine trajectories for executing grasps of objects in bins without colliding with the bin, for instance walls of the bin.

### BACKGROUND

Autonomous operations, such as robotic grasping and manipulation, in unknown or dynamic environments present various technical challenges. Autonomous operations in dynamic environments may be applied to mass customization (e.g., high-mix, low-volume manufacturing), on-demand flexible manufacturing processes in smart factories, warehouse automation in smart stores, automated deliveries from distribution centers in smart logistics, and the like. In order to perform autonomous operations, such as grasping and manipulation, in some cases, robots may learn skills using machine learning, in particular deep neural networks or reinforcement learning.

In particular, for example, robots might interact with different objects under different situations. Some of the objects might be unknown to a given robot. Bin picking is an example operation that robots can perform using artificial intelligence (AI) or computer vision techniques. AI bin picking refers to a robot grasping objects that can define random or arbitrary poses, from a container or bin. The robot can move or transport the objects, and place them at a different location for packaging or further processing. It is recognized herein, however, that current approaches to robotic picking lack efficiency and capabilities. In particular, current approaches often do not properly or efficiently identify certain clearances associated with a given robot to execute various grasps, due to various technical challenges in doing so.

### BRIEF SUMMARY

Embodiments of the invention address and overcome one or more of the described-herein shortcomings or technical problems by providing methods, systems, and apparatuses for determining, during runtime of a robot, various clearance dimensions associated with the robot executing a grasp. In particular, for example, during runtime the robot can determine trajectories for executing grasps of objects in bins without colliding with the bin, for instance walls of the bin.

In an example aspect, an autonomous system includes a robot configured to operate in an active industrial runtime so as to define a runtime. The robot includes an end effector configured to grasp a plurality of objects within a bin, in particular within walls of the bin that is within a workspace of the robot. The autonomous system further includes a processor and a memory storing instructions that, when executed by the processor, cause the autonomous system to perform various operations. In particular, the system can obtain dimensions of a bin within the workspace. The bin is capable of containing one or more of the plurality of objects within one or more walls of the bin. Based on the dimensions, during runtime, the system can determine planes that represent the one or more walls of the bin, and the system can obtain properties of the end effector. The system can determine a grasp point and a grasp nominal line. The grasp point can define a location of the end effector within the one or more walls of the bin, and the grasp nominal line can define a position of the end effector to perform a grasp at the grasp point to perform a grasp at the grasp point. During runtime and before performing the grasp, based on the planes that represent the one or more walls of the bin, the properties of the end effector, the grasp point, and the grasp nominal line, the system can determine whether the end effector collides with the one or more walls when performing the grasp.

### BRIEF DESCRIPTION OF THE SEVERAL VIEWS OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 shows an example autonomous system in an example physical environment that includes a bin capable of containing various objects, in accordance with an example embodiment.

FIG. 2 is a flow diagram that illustrations example operations that can be performed by the autonomous system at runtime, so as to determine whether a robot of the autonomous system might collide with a bin during a grasp, in accordance with an example embodiment.

FIG. 3 illustrates an example collision check that the system can perform, in accordance with an example embodiment.

FIG. 4 illustrates another example collision check that the system can perform, in accordance with another example embodiment.

FIG. 5 illustrates yet another example collision check that the system can perform, in accordance with yet another example embodiment.

FIG. 6 illustrates a computing environment within which embodiments of the disclosure may be implemented.

FIG. 7 illustrates an example operation that can be performed by the autonomous system before a collision check is performed, in accordance with an example embodiment.

### DETAILED DESCRIPTION

As an initial matter, robotic bin picking generally consists of a robot equipped with sensors or cameras, such that the robot can grasp (pick) objects in random poses from a container (bin) using a robotic end effector. In various examples described herein, objects can be known or known to the robot, and objects can be of the same type or mixed. In some cases, the robot performs a bin picking algorithm before each pick, so as to calculate and determine which grasp the robot executes next. In some cases, for example, computer vision systems estimate suitable grasp points in arbitrary bin configurations, wherein any number of objects may appear in arbitrary random positions. In particular, for example, a given robotic system can use a deep neural network that has been trained to determine grasp points, to compute grasp points based on captured images or depth maps. It is recognized herein, however, that a technical problem involved in robotic grasping is assessing or determining whether a given grasp satisfies various safety parameters. It is also recognized herein that in various examples the next grasping point is only known at runtime, such that the grasps cannot be pre-taught, and safety clearances associated with a given newly computed grasp might need to be established prior to the execution of the grasp. In particular, by way of example and without limitation, a given system might establish safety by determining a clearance required for a given robotic arm to execute a given grasp without colliding with the walls of a bin.

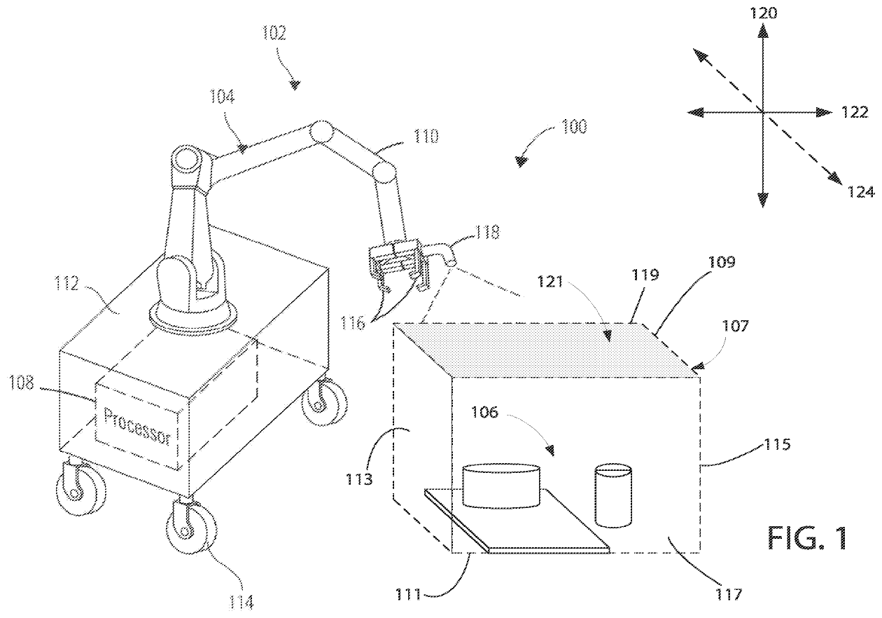

Referring now to FIG. 1, an example industrial or physical environment or workspace 100 is shown. As used herein, a physical environment or workspace can refer to any unknown or dynamic industrial environment. Unless otherwise specified, physical environment and workspace can be used interchangeably herein, without limitation. A reconstruction or model may define a virtual representation of the physical environment or workspace 100, or one or more objects 106 within the physical environment 100. For purposes of example, the objects 106 can be disposed in a bin or container, for instance a bin 107, in various arbitrary configurations so as to be positioned for grasping. Unless otherwise specified herein, bin, container, tray, box, or the like can be used interchangeably, without limitation. By way of example, the object 106s can be picked from the bin 107 by one or more robots, and transported or placed in another location, for instance outside the bin 107. The example objects 106 define various shapes and sizes, though it will be understood that the objects 106 can be alternatively shaped or define alternative structures as desired, and all such objects are contemplated as being within the scope of this disclosure.

The physical environment 100 can include a computerized autonomous system 102 configured to perform one or more manufacturing operations, such as assembly, transport, or the like. The autonomous system 102 can include one or more robot devices or autonomous machines, for instance an autonomous machine or robot device 104, configured to perform one or more industrial tasks, such as bin picking, grasping, or the like. The system 102 can include one or more computing processors configured to process information and control operations of the system 102, in particular the autonomous machine 104. The autonomous machine 104 can include one or more processors, for instance a processor 108, configured to process information and/or control various operations associated with the autonomous machine 104. An autonomous system for operating an autonomous machine within a physical environment can further include a memory for storing modules. The processors can further be configured to execute the modules so as to process information and generate models based on the information. It will be understood that the illustrated environment 100 and the system 102 are simplified for purposes of example. The environment 100 and the system 102 may vary as desired, and all such systems and environments are contemplated as being within the scope of this disclosure.

Still referring to FIG. 1, the autonomous machine 104 can further include a robotic arm or manipulator 110 and a base 112 configured to support the robotic manipulator 110. The base 112 can include wheels 114 or can otherwise be configured to move within the physical environment 100. The autonomous machine 104 can further include an end effector 116 attached to the robotic manipulator 110. The end effector 116 can include one or more tools configured to grasp and/or move objects 106. Example end effectors 116 include finger grippers or vacuum-based grippers. The robotic manipulator 110 can be configured to move so as to change the position of the end effector 116, for example, so as to place or move objects 106 within the physical environment 100. The system 102 can further include one or more cameras or sensors, for instance a three-dimensional (3D) point cloud camera 118, configured to detect or record objects 106 within the physical environment 100. The camera 118 can be mounted to the robotic manipulator 110 or otherwise configured to generate a 3D point cloud of a given scene, for instance the physical environment 100. Alternatively, or additionally, the one or more cameras of the system 102 can include one or more standard two-dimensional (2D) cameras that can record or capture images (e.g., RGB images or depth images) from different viewpoints. Those images can be used to construct 3D images. For example, a 2D camera can be mounted to the robotic manipulator 110 so as to capture images from perspectives along a given trajectory defined by the manipulator 110.

Still referring to FIG. 1, the camera 118 can be configured to capture images of the bin 107, and thus the objects 106, along a first or transverse direction 120. In some cases, a deep neural network is trained on a set of objects. Based on its training, the deep neural network can calculate grasp scores for respective regions of a given object, for instance an object within the bin 107. For example, the robot device 104 and/or the system 102 can define one or more neural networks configured to learn various objects so as to identify poses, grasp points (or locations), and/or or affordances of various objects that can be found within various industrial environments. An example system or neural network model can be configured to learn objects and grasp locations, based on images for example, in accordance with various example embodiments. After the neural network is trained, for example, images of objects can be sent to the neural network by the robot device 104 for classification, in particular classification of grasp locations or affordances.

Bin picking is an example operation that robots can perform using artificial intelligence (AI) or computer vision techniques. It is recognized herein that AI-techniques typically aim at solving bin picking with a model free-approach, such that various objects can be picked from a bin, thereby defining a generic bin picking skill. It is also recognized herein that traditional computer vision techniques typically define a model-based approach, in which a representation (e.g., CAD model, pictures, or other features) of a given object is known, such that the computer vision system can identity the given object or features of the given object in an image that is captured of a bin containing the object at runtime. Based on the image, the system can locate and pick the given object in the bin that can contain multiple other objects.

Embodiments described herein can be implemented in the above-described scenario, and thus can define a model-based approach.

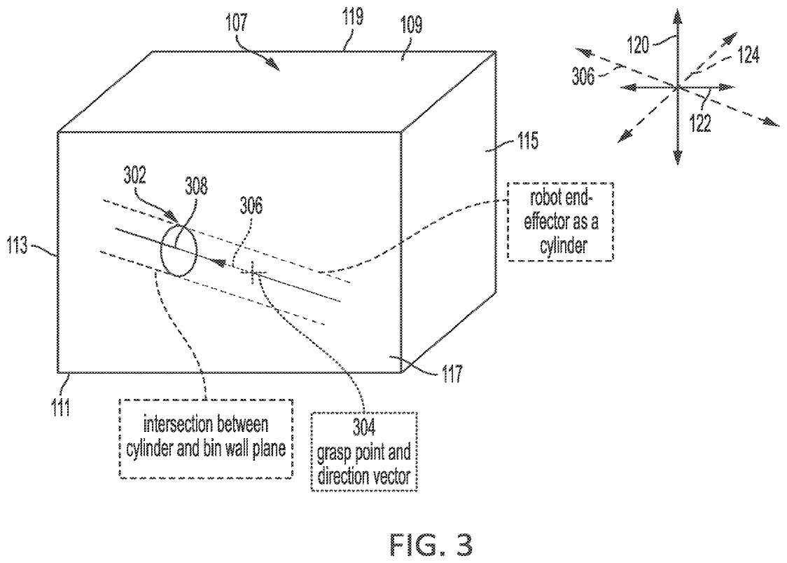

Referring also to FIG. 3, the bin 107 can define a top 109 end and a bottom end 111 opposite the top end 109 along the transverse direction 120. The bin 107 can further define a first side 113 and a second side 115 opposite the first side 113 along a second or lateral direction 122 that is substantially perpendicular to the transverse direction 120. The bin 107 can further define a front end 117 and a rear end 119 opposite the front end 117 along a third or longitudinal direction 124 that is substantially perpendicular to both the transverse and lateral directions 120 and 122, respectively. Thus, the first side 113, second side 115, front end 117 and rear end 119 can define walls of the bin 107. Though the illustrated bin 107 defines a rectangular shape, it will be understood that bins or containers can be alternatively shaped or sized, and all such bins or containers are contemplated as being within the scope of this disclosure. By way of example, the bin 107 may be alternatively shaped so as to define fewer than, or greater than, four walls.

It is recognized herein that alternative approaches to avoiding collisions during grasping lack efficiencies or capabilities that result from embodiments described herein. In an alternative approach, for example, an entire workspace or work cell can be modeled in a simulation environment, such that respective collision geometries can be determined for each object, bin, and robot associated with the workspace. Using the collision geometries, the simulation environment can perform holistic collision checking and collision avoidance algorithms. It is recognized herein, however, that such simulation environments can be difficult to engineer and maintain, and are often far too slow with respect to runtime execution, which can negatively affect cycle time performance. In accordance with various embodiments described herein, however, collision checks can be performed at runtime and at an efficient speed so as to avoid negatively affecting the cycle time performance. Runtime can define an instance of a bin picking operation during which a computer vision system or AI system is being executed in a production environment. In some cases, cycle time performance is defined by the number of picks per a unit of time, such as an hour, for example.

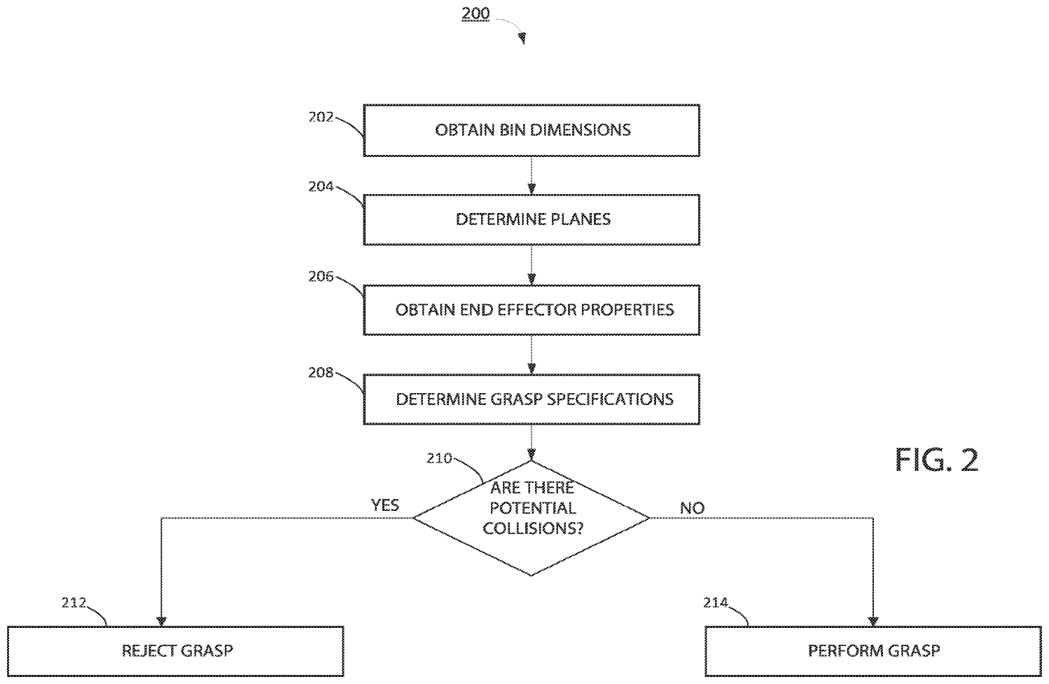

Referring also to FIG. 2, example operations 200 are shown that can be performed by a computing system, for instance the autonomous system 102. At 202, the system 102 can obtain geometric dimensions associated with a bin at-issue, for instance the bin 107 that is positioned within the environment 100. The geometric dimensions, or bin definition, can be determined from the coordinates (e.g., X, Y, Z) of the vertices of each of the bin walls. In various examples, as further described below, these coordinates are defined in the same coordinate reference system as the grasp point and direction vector, so that the collision check can be performed in a coherent coordinate space. By way of example, a given reference coordinate system can be defined by the robot 104 or the camera system (e.g., sensor 118). Based on the reference coordinate system, the system 102 can perform hand-eye calibration so as to determine the transformation between the relevant coordinate systems (e.g., the robot coordinate system and the camera coordinate system). Given the transformation between coordinate systems, it is possible to translate a world location (e.g., one of the vertices of the bin) from one coordinate system to the other. The system 102 may also employ automatic bin detection algorithms to determine the position (e.g., coordinates in the camera frame) of the bin 107 based on the an image that is captured of the bin 107. Alternatively, or additionally, when a bin pose is fixed so as to not move, for example, the pose of the bin can be defined manually by an operator or commission, in the robot coordinate system or the camera coordinate system. In other examples in which the bin pose or position might be variable, the pose can be determined by the system 102, for instance by performing hand-eye calibration. Based on the bin pose and geometric dimensions of the bin (e.g., height, width, length), the position (e.g., X, Y, Z coordinates) of the vertices of the relevant bin walls can be computed, for instance by performing linear transformations. By way of example, and without limitation, the bin pose may define the position and orientation of the center point of the bin 107 with respect to the reference coordinate system, such that the X, Y, Z positions of the vertices of the relevant bin walls can be computed by applying straightforward linear transformations, given the bin's height, width and length.

In some cases, the system 102, in particular the camera 118, can capture an image of the bin 107 and identify the bin 107. In response to identifying the bin, the system 118 can retrieve the dimensions of the identified bin from memory. Alternatively, or additionally, in an example in which the system 102 has not previously detected the bin 107, such that the bin defines a new bin, a user can input the dimensions of the bin 107 via a user interface of the system 102. For example, in some cases, the system 102 can retrieve a bin geometry specification that defines the geometric dimensions of a bin, for instance the bin 107. By way of example, the bin geometry specification can indicate the height and length defined by each of the ends or sides of the bin. In particular, the specification can indicate the distance along the transverse direction 120 (e.g., height) defined by each wall of the bin 107, for instance the first side 113, second side 115, front end 117 and rear end 119. The geometric dimensions of the bin 107 that are obtained by the system 107 can further indicate the distances along the lateral direction 122 (lengths) defined by the front end 117 and rear end 119, and the distances along the longitudinal direction 124 (lengths) defined by the first side 113 and second side 115. Furthermore, the geometric dimensions of the bin 107 that are obtained by the system 107 can further indicate the dimensions of the bottom end 111, for instance the distance along the lateral direction 122 defined by the bottom end 111 and the distance along the longitudinal direction 124 defined by the bottom end 111.

Still referring to FIG. 2, at 204, based on the geometric dimensions of the bin 107, the system 102 can determine planes for walls of the bin 107. In some cases, the geometric dimensions define vertices (e.g., X, Y, Z coordinates) for each bin wall. Thus, in an example, each bin wall of the bin 107 can define four vertices, such that three of the four vertices (e.g., points) define a plane as long as the three points are not on the same line, which is not the case in the example bin 107. Planes in 3D space are infinite. Thus, the system 102 uses the fourth point, with the other three points of a given wall, to determine boundaries of the plane defined by the wall. For example, the system 102 can identify minimum and maximum values of the coordinates of the vertices, so as to determine boundaries of a given plane associated with a respective bin wall. Thus, the system 102 can determine and compute plane equations that define a respective plane upon which each wall lies. The plane equations can further define boundaries associated with each plane, thereby defining a closed plane associated with each wall of the bin 107. After the plane equations are computed for a respective bin, the associated closed planes can be stored, such that the closed planes can be retrieved by the system 102 a subsequent time that the bin 107, or other bins having the same geometric dimensions of the bin 107, is identified within the environment 100. At 206, the system 102 can receive or otherwise obtain properties of end effectors, for instance the end effector 116. In some examples, the properties can be determined from a CAD model, or the like, of the end effector 116. In particular, for example, the radius and length of a cylinder can be determined from a CAD model of an end effector that is substantially shaped like a cylinder. By way of further example, the height, width, and length of a cuboid can be determined from a CAD model of an end effector that is substantially shaped like a cuboid. In some cases, the system 102 can retrieve an end-effector specification that defines various physical and operating parameters of the end effector 116. Such a specification can be input from a user of the system 102. For example, the specification can define geometric dimensions of the end effector 116. Additionally, or alternatively, the specification can include parameters related to how the end effector moves and functions so as to grasp objects. By way of example, in cases in which the end effector 116 defines a vacuum-based gripper, for instance a gripper that includes a suction cup, the geometric dimensions of the end effector 116 can define a thin tube or cylinder 302 as it moves (see FIG. 3), such that the end effector 116 can define a cylindrical end effector. By way of further example, the suction cup can define the radius of the cylinder 302, and thus the cylindrical end effector.

Still referring to FIG. 2, at 208, the system can 102 can determine, or otherwise obtain, a grasp specification associated with the end effector 116. Referring also to FIG. 3, the grasp specification can define a grasp point 304. The grasp point 304 can define the point of contact where the end effector 116 touches the object being grasped, during the grasp. The grasp point 304 can define coordinates (e.g., X, Y, Z) in the reference coordinate system. Thus, the grasp point 304 can define the location or position of the end effector 116 in space when performing a grasp. In particular, the grasp point 304 can define the location of the end effector 116 within the walls of the bin 107, and thus within the bin 107, when performing a grasp at the grasp point 304. For example, the grasp point 304 can be based on the center of a suction cup represented by the cylinder 302. In some cases, the grasp point 304 is defined by the output of an AI or computer vision module that computes grasp points on the fly, based on one or more images of the scene that are captured, for instance by the camera 118.

The grasp specification can further define a grasp direction or grasp nominal line 306. The grasp nominal line 306 can define an angle of attack, or a direction (e.g., Euler angle or normal vector) from the grasp point 304 that represents the end effector 116. In some cases, the grasp nominal line is defined by the output of the AI or computer vision module that can compute grasps on the fly. In particular, in some examples, the grasp nominal line 306 is defined by the normal vector of the plane on which the grasp point 304 lies. Thus, the grasp nominal line 306 can define an angle or position of the end effector 116 at the grasp point 304, or the destination for grasping. Grasp nominal lines, for instance the grasp nominal line 306, can also define a direction along which the end effector 116 moves so as to perform a grasp at respective grasp points, for instance the grasp point 304. Referring in particular to FIG. 3, the grasp nominal line 306 can define a direction along which the end effector moves toward a given object to grasp the object, and the direction along which the end effector moves away from the object so as to carry the object after the grasp. In the illustrated example, the grasp nominal line 306 defines a vector that is angularly offset as compared to the transverse direction 120, lateral direction 122, and longitudinal direction 124, though it will be understood that grasp lines can vary based on a given robot and grasp point, and all such grasp lines are contemplated as being within the scope of this disclosure.

Referring again to FIGS. 2 and 3, at 210, based on the closed planes defined by the walls of the bin 107, the grasp specification including the grasp point 304 and the grasp nominal 306, and the properties of the end effector 116, the system 102 can determine whether there are potential collisions between the end effector 116 and each wall of the bin 107.

Referring in particular to FIG. 3, at 210, based on the system 102 determining that the end effector defines the cylinder 302 as the end effector moves toward the grasp point 304 along the grasp nominal line 306, and away from the grasp point 304 along the grasp nominal line 306, the system 302 can determine that there is a potential collision. In particular, the system can determine a collision location 308 on the closed plane defined by the front end 117 (wall) of the bin 107. A collision can be determined based on whether the grasp nominal line 306, which can be defined by a the grasp point 304 and the grasp direction vector, intersects with any of the bin walls (closed planes) so as to define an intersection point between the grasp nominal line and a closed plane. In some cases, to determine whether there is an intersection point, the line equation that defines the grasp nominal line 306 is equated with the (infinite) plane equation that represents a bin wall, and the resulting equation is solved for the coordinates X, Y, Z. In an example, the coordinates X, Y, and Z can define coordinates along the lateral, longitudinal, and transverse directions 122, 124, and 120, respectively. If the system does not find a solution to the equation, then there is no intersection, and thus the system determines that there is no collision. When a solution is found, in various examples, the intersection point (e.g., represented by X, Y, Z coordinates) can be checked to determine whether it lies within the boundaries of one of the closed planes that represent the bin walls. When the intersection lies within the boundaries, the system can determine that a collision will occur at the intersection point, for instance at the collision point 308.

Thus, the collision location 308 can define an area of the bin 107, in particular the walls of the bin 107, in which the end effector 116 might collide during a given grasping operation. Referring again to FIG. 2, at 212, responsive to determining the potential collision, in particular the collision location 308, the system 102 can reject the grasp associated with the grasp point 304. In some cases, based on the grasp point 304 being rejected, the system can request that a new grasp be computed, for instance by an AI or computer vision system. Alternatively, when the system 102 determines that there are no potential collisions between the end effector 116 and the bin 107, or when the system 102 fails to discover any potential collisions with any of the walls of the bin 107, the system 102 can proceed to validate the grasp, at 214. In some cases, responsive to a grasp associated with the grasp point 304 being validated, the robot 104 can proceed to perform the grasp at 214.

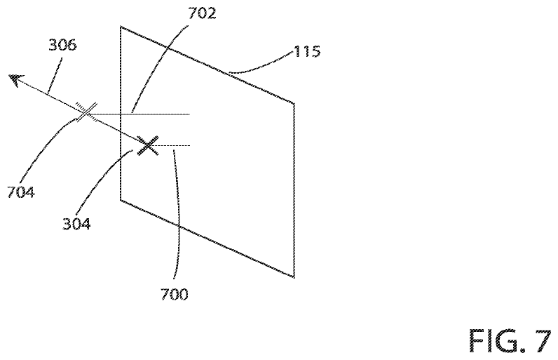

Referring also to FIG. 7, in accordance with an example embodiment, before performing the collision check at 210 for an inclined grasp (e.g., angularly offset with respect to the transverse direction 120), the system 202 can make a determination as to whether the grasp direction vector moves toward or away from a particular closed plane that represents a bin wall. If the direction vector points away from the closed plane, and thus the associated bin wall, the system can determine that there is no collision with that wall before performing collision check at 210. If the direction vector points toward the closed plane, and thus the bin wall, the system can determine that there might be a collision with that wall, and thus the system can proceed to perform the collision check with that wall, at 210. Thus, in some cases, computational processing overhead can be conserved because the collision check need not be performed on all bin walls, for instance all bin walls defined by the bin 107. Rather, in some cases, the collision check (at 210) might only be performed with respect to less than all of the walls, for instance one wall.

With particular reference to FIG. 7, by way of example, the grasp direction vector and the grasp point 304 can define the grasp nominal line 306. The grasp nominal line 304 can be checked to determine whether the direction of the associated grasp at the grasp point 304 moves away or toward the walls of the bin 107, of instance the wall defined by second side 115. For example, the system 102 can check whether the grasp nominal line 306 gets closer to (or farther from) the second side 115 along the direction defined by the grasp direction vector from the grasp point 304. In an example, because the grasp nominal line 306 moves away from the second side 115, the system 102 can determine that there is no collision with that wall (second side 115) and no further checks need to be done such that intersection of the line 306 and the plane defined by the second side 115 is not computed. To determine whether the grasp nominal line moves toward or away from a given wall, by way of example, the system 102 can determine the perpendicular distance from the grasp point to the wall. For example, referring to FIG. 3, the system 102 can determine a first perpendicular distance 700 from the grasp point 304 to the second side 115. The perpendicular distance 700 defines a normal vector from the closed plan defined by the second side 115. Furthermore, the system 102 can select a point 704 along the grasp nominal line 306, in particular along the positive grasp direction from the grasp point 304. The system can determine a second perpendicular distance 702 from the selected point 704 to the second side 115. The second perpendicular distance 702 defines a normal vector from the closed plan defined by the second side 115. If the second perpendicular distance 702 is greater than the first perpendicular distance 700, the system 102 can determine that there is no collision with the second side 115, and thus the system 102 can refrain from the performing the collision check (at 210) with the closed plane defined by the second side 115. If the second perpendicular distance 702 is less than the first perpendicular distance 700, the system 102 can determine that there could be collision with the second side 115, and thus the system 102 can proceed with performing the collision check (at 210) with the closed plane defined by the second side 115.

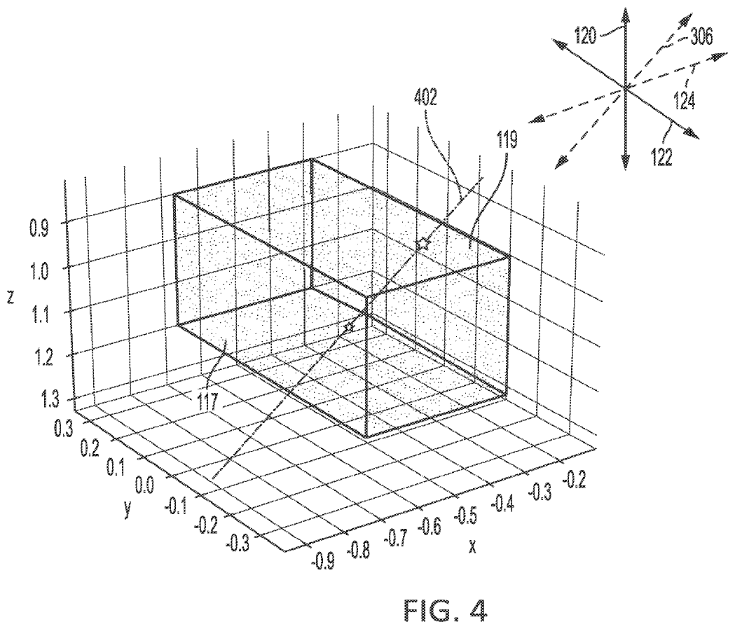

Referring now to FIG. 4, the system 102 can determine (at 210) whether end effectors defining various geometries might collide with bins, in particular bin walls. For example, the system 102 can model some end effectors, for instance suction cub end effectors that define a thin tube, as lines, for instance a line 402. In the example, the system determines that the line 402 that represents an end effector can collide with a closed plane, in particular the closed plane that represents the rear end 119.

In some examples, a bin picking engineer or the system can determine whether a given end effector can be modeled with a line. Such a determination can depend on the compliance of the robot and/or the bin, and the associated risks of a collision (e.g., breaking equipment, spillage, etc.). For example, if the robot can bounce back or recover from a potential, there might be less risk in modeling the end effector as a line. Additionally, or alternatively, if the bin walls are rather yielding, there might be less risk. In various examples, these factors are weighed in together with the thickness of the end effector such that even in “yielding” setups, the robot can reach the grasp final location with enough precision to succeed. By way of example, and without limitation, an end effector defining a 1 centimeter radius performing a grasp in a mildly yielding environment might be sufficiently well approximated by an ideal single line collision check.

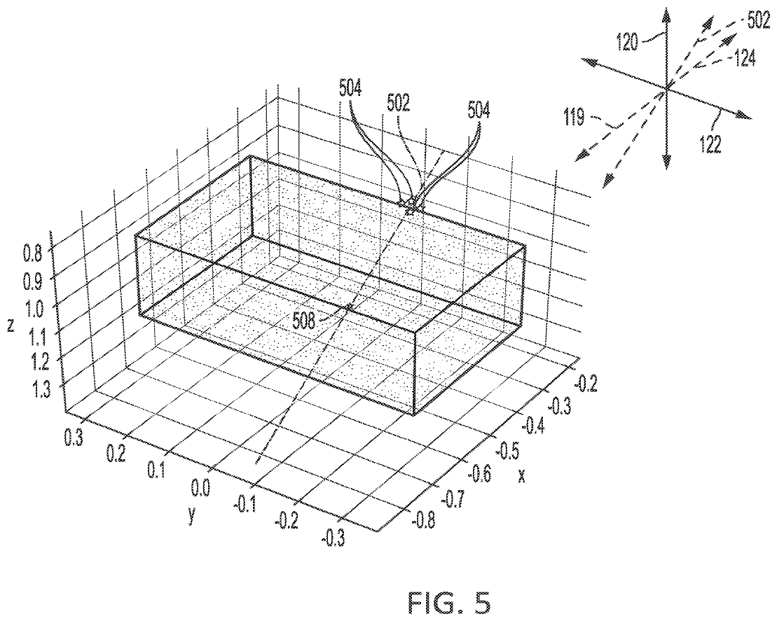

By way of further example, referring also to FIG. 5, at 210, the system 102 can determine whether end effectors having non-negligible volumes might collide with bins during grasping. Such end effectors might, by way of example and without limitation, define substantially cylindrical or substantially cuboid shapes. The system 102 can section a representative dimension of the shape associated with the end effector, so as to determine potential collisions without having to model the precise or exact geometry of the end effector. For example, the system 102 can perform a collision check (at 210) using the radius of a cylinder that represents the end effector. By way of further example, the system 102 can perform a collision check (at 210) using the width of a cuboid that represents the end effector. In the above examples, the radius and the width each define the representative dimension of the shape associated with respective end effectors.

With continuing reference to FIG. 5, a grasp nominal line 502 can be defined at the center of the representative dimension. During the collision check, the grasp nominal line 502 can be displaced in a plurality of directions, by a distance equal to the representative dimension, so as to define sample points 506 that represent outermost points or boundaries of the shape associated with the end effector. In the illustrated example, the grasp nominal line 502 is displaced up and down along the transverse direction 120, and left and right along the lateral direction 122, so as define four sample points 506. It will be understood, however, that the sample points 506 are presented by way of example, thus the system can display the grasp nominal line 502 in any number of directions (e.g., more or less than four) so as to define any number of line approximations representative of the end effector enclosure, and all such line approximations are contemplated as being within the scope of this disclosure.

Still referring to FIG. 5, by way of example, the sample points 506 can be defined at a distance equal to the representative dimension (e.g., radius, width, etc.) away from the grasp nominal line 502 along the transverse and lateral directions 120 and 122, respectively. During the collision check at 210, the system 102 can move the sample points 506 along the grasp nominal line 502 toward and away from a grasp point 508, so as to define line approximations at the boundaries represented by the sample points 506. Thus, the system 102 can determine whether the boundary of the shape associated with the end effector, which is represented by the sample points 506, can collide with the walls of the bin 107 during a grasping operation.

In some cases, the grasp nominal line (or grasp direction vector) can be aligned with the transverse direction 120 so as to define a vertical vector. In such an example, the system 102 can perform a proximity check instead of performing the line collisions as described above. For example, referring to FIG. 5, the grasp point 508 can define coordinates in space. Similarly, walls of the bin can define coordinates in space. The system 102 can compare the coordinates of the grasp point 508 to each of the coordinates of the bin walls. In particular, the system 102 can determine a distance between the coordinates of the grasp point to coordinates of the bin walls, for instance along the lateral and longitudinal directions 122 and 124, respectively. The system 102 can compare each of the distances to a predetermined tolerance that is based on the representative dimension of the end effector (e.g., radius, width, etc.) When a distance is less than the predetermined tolerance, the system 102 can determine that a collision may occur, and thus the associated grasp can be rejected. When each distance is greater than the predetermined tolerance, the system 102 can determine that the associated grasp can proceed without the end effector colliding with the bin walls, thereby validating the grasp.

Thus, as described herein, an autonomous system that includes a robot, at runtime, can validate grasps or determine whether grasps will result in the end effector colliding with a bin. In particular, the system can approximate the end effector so as define geometric shapes or lines that represent boundaries of the end effector. Before a given grasp of an object in a bin is performed, the system can determine whether those boundaries will collide with walls of the bin during the grasp. Without being bound by theory, as grasps change or as new grasps are encountered, embodiments described herein provide a cost-effective technical solution to ensure collision safety prior to execution of the grasp. It is recognized herein that performing grasps without checking whether the end effector might collide with the bin can result in costly collisions (e.g., damage to objects or robot) or inefficient performance (e.g., grasps that are dropped due to collisions), among other issues.

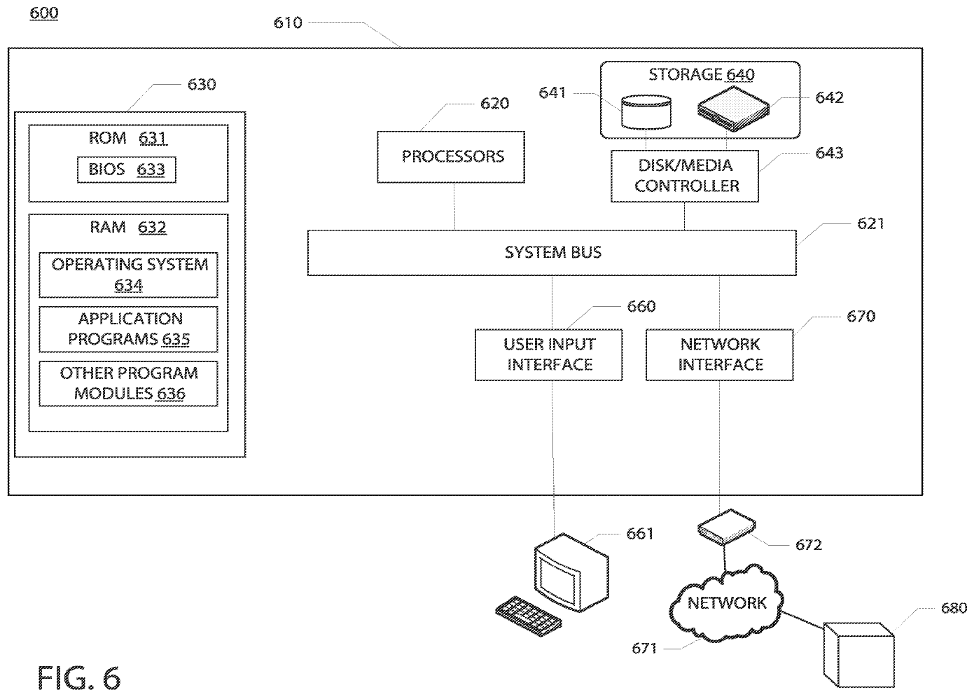

FIG. 6 illustrates an example of a computing environment within which embodiments of the present disclosure may be implemented. A computing environment 600 includes a computer system 610 that may include a communication mechanism such as a system bus 621 or other communication mechanism for communicating information within the computer system 610. The computer system 610 further includes one or more processors 620 coupled with the system bus 621 for processing the information. The autonomous system 102 may include, or be coupled to, the one or more processors 620.

The processors 620 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 620 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 621 may include at least one of a system bus, a memory bus, an address bus, or a message bus, and may permit exchange of information (e.g., data (including computer-executable code), signaling, etc.) between various components of the computer system 610. The system bus 621 may include, without limitation, a memory bus or a memory controller, a peripheral bus, an accelerated graphics port, and so forth. The system bus 621 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 6, the computer system 610 may also include a system memory 630 coupled to the system bus 621 for storing information and instructions to be executed by processors 620. The system memory 630 may include computer readable storage media in the form of volatile and/or nonvolatile memory, such as read only memory (ROM) 631 and/or random access memory (RAM) 632. The RAM 632 may include other dynamic storage device(s) (e.g., dynamic RAM, static RAM, and synchronous DRAM). The ROM 631 may include other static storage device(s) (e.g., programmable ROM, erasable PROM, and electrically erasable PROM). In addition, the system memory 630 may be used for storing temporary variables or other intermediate information during the execution of instructions by the processors 620. A basic input/output system 633 (BIOS) containing the basic routines that help to transfer information between elements within computer system 610, such as during start-up, may be stored in the ROM 631. RAM 632 may contain data and/or program modules that are immediately accessible to and/or presently being operated on by the processors 620. System memory 630 may additionally include, for example, operating system 634, application programs 635, and other program modules 636. Application programs 635 may also include a user portal for development of the application program, allowing input parameters to be entered and modified as necessary.

The operating system 634 may be loaded into the memory 630 and may provide an interface between other application software executing on the computer system 610 and hardware resources of the computer system 610. More specifically, the operating system 634 may include a set of computer-executable instructions for managing hardware resources of the computer system 610 and for providing common services to other application programs (e.g., managing memory allocation among various application programs). In certain example embodiments, the operating system 634 may control execution of one or more of the program modules depicted as being stored in the data storage 640. The operating system 634 may include any operating system now known or which may be developed in the future including, but not limited to, any server operating system, any mainframe operating system, or any other proprietary or non-proprietary operating system.

The computer system 610 may also include a disk/media controller 643 coupled to the system bus 621 to control one or more storage devices for storing information and instructions, such as a magnetic hard disk 641 and/or a removable media drive 642 (e.g., floppy disk drive, compact disc drive, tape drive, flash drive, and/or solid state drive). Storage devices 640 may be added to the computer system 610 using an appropriate device interface (e.g., a small computer system interface (SCSI), integrated device electronics (IDE), Universal Serial Bus (USB), or FireWire). Storage devices 641, 642 may be external to the computer system 610.

The computer system 610 may also include a field device interface 665 coupled to the system bus 621 to control a field device 666, such as a device used in a production line. The computer system 610 may include a user input interface or GUI 661, which may comprise one or more input devices, such as a keyboard, touchscreen, tablet and/or a pointing device, for interacting with a computer user and providing information to the processors 620.

The computer system 610 may perform a portion or all of the processing steps of embodiments of the invention in response to the processors 620 executing one or more sequences of one or more instructions contained in a memory, such as the system memory 630. Such instructions may be read into the system memory 630 from another computer readable medium of storage 640, such as the magnetic hard disk 641 or the removable media drive 642. The magnetic hard disk 641 (or solid state drive) and/or removable media drive 642 may contain one or more data stores and data files used by embodiments of the present disclosure. The data store 640 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 620 may also be employed in a multi-processing arrangement to execute the one or more sequences of instructions contained in system memory 630. In alternative embodiments, hard-wired circuitry may be used in place of or in combination with software instructions. Thus, embodiments are not limited to any specific combination of hardware circuitry and software.

As stated above, the computer system 610 may include at least one computer readable medium or memory for holding instructions programmed according to embodiments of the invention and for containing data structures, tables, records, or other data described herein. The term “computer readable medium” as used herein refers to any medium that participates in providing instructions to the processors 620 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 641 or removable media drive 642. Non-limiting examples of volatile media include dynamic memory, such as system memory 630. Non-limiting examples of transmission media include coaxial cables, copper wire, and fiber optics, including the wires that make up the system bus 621. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 600 may further include the computer system 610 operating in a networked environment using logical connections to one or more remote computers, such as remote computing device 680. The network interface 670 may enable communication, for example, with other remote devices 680 or systems and/or the storage devices 641, 642 via the network 671. Remote computing device 680 may be a personal computer (laptop or desktop), a mobile device, a server, a router, a network PC, a peer device or other common network node, and typically includes many or all of the elements described above relative to computer system 610. When used in a networking environment, computer system 610 may include modem 672 for establishing communications over a network 671, such as the Internet. Modem 672 may be connected to system bus 621 via user network interface 670, or via another appropriate mechanism.

Network 671 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 610 and other computers (e.g., remote computing device 680). The network 671 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 671.

It should be appreciated that the program modules, applications, computer-executable instructions, code, or the like depicted in FIG. 6 as being stored in the system memory 630 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 610, the remote device 680, and/or hosted on other computing device(s) accessible via one or more of the network(s) 671, may be provided to support functionality provided by the program modules, applications, or computer-executable code depicted in FIG. 6 and/or additional or alternate functionality. Further, functionality may be modularized differently such that processing described as being supported collectively by the collection of program modules depicted in FIG. 6 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 6 may be implemented, at least partially, in hardware and/or firmware across any number of devices.

It should further be appreciated that the computer system 610 may include alternate and/or additional hardware, software, or firmware components beyond those described or depicted without departing from the scope of the disclosure. More particularly, it should be appreciated that software, firmware, or hardware components depicted as forming part of the computer system 610 are merely illustrative and that some components may not be present or additional components may be provided in various embodiments. While various illustrative program modules have been depicted and described as software modules stored in system memory 630, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. An autonomous system configured to operate in an active industrial environment so as to define a runtime, the autonomous system comprising:
a robot defining an end effector configured to grasp a plurality of objects within a workspace; and
a memory storing instructions that, when executed by the one or more processors, cause the autonomous system to, during the runtime:
obtain dimensions of a bin within the workspace, the bin capable of containing one or more of the plurality of objects within one or more walls of the bin;
based on the dimensions, determine planes that represent the one or more walls of the bin;
obtain properties of the end effector;
determine a grasp point and a grasp nominal line, the grasp point defining a location of the end effector within the one or more walls of the bin, and the grasp nominal line defining a position of the end effector to perform a grasp at the grasp point; and
based on the planes that represent the one or more walls of the bin, the properties of the end effector, the grasp point, and the grasp nominal line, before performing the grasp, determine whether the end effector collides with the one or more walls when performing the grasp.

2. The autonomous system as recited in claim 1, the memory further storing instructions that, when executed by the one or more processors, cause the autonomous system to, during the runtime:
based on the end effector properties, identify a geometric shape that represents the end effector.

3. The autonomous system as recited in claim 2, wherein the geometric shape is a cylinder, cuboid, or line.

4. The autonomous system as recited in claim 2, the memory further storing instructions that, when executed by the one or more processors, cause the autonomous system to, during the runtime:
based on the geometric shape, determine a geometric dimension of the geometric shape; and
move the geometric shape along the grasp nominal line so as to determine whether the end effector collides with the one or more walls,
wherein the geometric dimension represents a dimension of the end effector measured along a first direction substantially perpendicular to the grasp nominal line.

5. The autonomous system as recited in claim 1, the memory further storing instructions that, when executed by the one or more processors, cause the autonomous system to, during the runtime:
determine a first perpendicular distance from a first wall of the one or more walls to the grasp point, the first perpendicular distance defining a first normal vector from the second first wall;
select a point along the grasp nominal line so as to define a selected point; and
determine a second perpendicular distance from the first wall to the selected point, the second perpendicular distance defining a second normal vector from the first wall.

6. The autonomous system as recited in claim 5, the memory further storing instructions that, when executed by the one or more processors, cause the autonomous system to, during the runtime:
compare the first perpendicular distance to the second perpendicular distance; and
when the first perpendicular distance is less than the second perpendicular distance, determine that the end effector does not collide with the first wall when performing the grasp.

7. The autonomous system as recited in claim 1, the memory further storing instructions that, when executed by the one or more processors, cause the autonomous system to, during the runtime:
determine that the end effector collides with the one or more walls when performing the grasp; and
reject the grasp such that the grasp is not performed.

8. The autonomous system as recited in claim 1, the memory further storing instructions that, when executed by the one or more processors, cause the autonomous system to, during the runtime:
determine that the end effector does not collide with the one or more walls when performing the grasp; and
perform the grasp.

9. A method performed by an autonomous system that includes a robot operating in an active industrial environment so as to define a runtime, the robot defining an end effector configured to grasp a plurality of objects within a workspace, the method comprising:
obtaining dimensions of a bin within the workspace, the bin capable of containing one or more of the plurality of objects within one or more walls of the bin;
based on the dimensions, determining planes that represent the one or more walls of the bin;
obtaining properties of the end effector;
determining a grasp point and a grasp nominal line, the grasp point defining a location of the end effector within the one or more walls of the bin, and the grasp nominal line defining a defining a position of the end effector to perform a grasp at the grasp point to perform a grasp at the grasp point; and
based on the planes that represent the one or more walls of the bin, the properties of the end effector, the grasp point, and the grasp nominal line, before performing the grasp, determining whether the end effector collides with the one or more walls when performing the grasp.

10. The method as recited in claim 9, the method further comprising, during the runtime:
based on the end effector properties, identifying a geometric shape that represents the end effector.

11. The autonomous system as recited in claim 10, wherein the geometric shape is a cylinder, cuboid, or line.

12. The method as recited in claim 10, the method further comprising, during the runtime:
based on the geometric shape, determining a geometric dimension of the geometric shape; and
moving the geometric shape along the grasp nominal line so as to determine whether the end effector collides with the one or more walls,
wherein the geometric dimension represents a dimension of the end effector measured along a first direction substantially perpendicular to the grasp nominal line.

13. The method as recited in claim 9, the method further comprising:
determining a first perpendicular distance from a first wall of the one or more walls to the grasp point, the first perpendicular distance defining a first normal vector from the second first wall;
selecting a point along the grasp nominal line so as to define a selected point;
determining a second perpendicular distance from the first wall to the selected point, the second perpendicular distance defining a second normal vector from the first wall;
comparing the first perpendicular distance to the second perpendicular distance; and
when the first perpendicular distance is less than the second perpendicular distance, determining that the end effector does not collide with the first wall when performing the grasp.

14. The autonomous system as recited in claim 9, the method further comprising, during the runtime:
determining that the end effector collides with the one or more walls when performing the grasp; and
rejecting the grasp such that the grasp is not performed.

15. The autonomous system as recited in claim 9, the method further comprising, during the runtime:
determining that the end effector does not collide with the one or more walls when performing the grasp; and
performing the grasp.
